(19) United States
(12) Patent Application Publication
(10) Pub. No.: US 2020/0139419 A1
(43) Pub. Date: May 7, 2020

(54) COMPACT INTELLIGENT LOADING AND UNLOADING DEVICE OF NUMERICAL CONTROL TURRET PUNCH PRESS

(71) Applicant: Hebei Hanzhi CNC Machine Co.,Ltd., Cangzhou (CN)

(72) Inventors: Changkui Xu, Cangzhou (CN); Jiaqiang Zhang, Cangzhou (CN); Xuezhi Wu, Cangzhou (CN); Nan Zhang, Cangzhou (CN)

(73) Assignee: Hebei Hanzhi CNC Machine Co.,Ltd.

(21) Appl. No.: 16/429,097

(22) Filed: Jun. 3, 2019

(30) Foreign Application Priority Data
Nov. 2, 2018 (CN) 201811299947.1

(51) Int. Cl. B21D 28/24; B21D 28/12; B21D 22/02

(52) U.S. Cl. CPC B21D 28/246; G05B 2219/45137; B21D 22/02; B21D 28/12

(57) ABSTRACT

The present invention provides a compact intelligent loading and unloading device of a numerical control turret punch press, comprising mounting frames, a palletizing platform, a mobile station, a feeding device, a lifting and reclaiming device and a central control module. The device can reduce the difficulty of a feeding device for clamping the sheet material through a clamp by lifting the sheet material with a certain angle at the front end of a mobile station. The device can also enhance the uniformity of the sheet material on a palletizing platform by arranging a limiting device on the palletizing platform, thereby reducing the probability of slippage of the sheet material on the palletizing platform.

### TECHNICAL FIELD

The present invention relates to the technical field of auxiliary apparatuses of numerical control devices, particularly to a compact intelligent loading and unloading device of a numerical control turret punch press.

### BACKGROUND

It is well known that with the progress of science and technology and the increase of labor cost, the requirements of the sheet metal industry for intelligent and unmanned devices are becoming more and more urgent. The numerical control turret punch press as main processing equipment of the sheet metal industry is controlled by a computer and is widely used in electrical switches, electronics, instrumentation, computers, textile machinery, office machinery and other industries. The numerical control turret punch press is a fastest-growing product in numerical control forging machinery, with large market shares. However, the numerical control turret punch press generally has a problem of low intelligence. Especially, the loading and unloading of the numerical control turret punch press are still completed manually, which is particularly not suitable for mass production and processing of products. A compact intelligent loading and unloading device of the numerical control turret punch press is a device used for intelligent loading and unloading of the numerical control turret punch press in the process of normal work of the numerical control turret punch press, and is widely used in the field of numerical control devices. The existing compact intelligent loading and unloading device of the numerical control turret punch press comprises mounting frames, a palletizing platform, a mobile station, a feeding device, a lifting and reclaiming device and a central control module. The front side and the rear side of the top end of the mounting frames are respectively provided with two sets of upper fixing frames. The left side and the right side of the lower end of the two sets of upper fixing frames are respectively provided with four sets of supporting legs. The front side and the rear side of the bottom ends of two sets of mounting frames are respectively provided with two sets of lower fixing frames. The front side and the rear side of the bottom end of the palletizing platform are respectively connected to the left side of the top end of the two sets of lower fixing frames. The top ends of the two sets of upper fixing frames are respectively provided with two sets of sliding rails. The front side and the rear side of the lower end of the mobile station are respectively slidably clamped with the two sets of sliding rails. A power device is disposed in a central portion of the bottom end of the mobile station. The power device is electrically connected to the central control module. The front end and the rear end of the feeding device are respectively provided with two sets of supporting frames. The bottom region of the feeding device is provided with a clamp. The bottom end of the feeding device is provided with a lifter. The bottom ends of the two sets of supporting frames are respectively connected to the central regions of the top front side and the top rear side of the two sets of upper fixing frames. The feeding device is internally provided with a drive module. The drive module is electrically connected to the central control module. The front end and the rear end of the lifting and reclaiming device are respectively provided with two sets of lifting devices. The bottom end of the lifting and reclaiming device is provided with an intelligent reclaiming module. A lifting device of the lifting and reclaiming device is provided with a driver. The driver and the intelligent reclaiming module are electrically connected to the central control module. The front side and the rear side of the left end of the central control module are respectively connected to the right ends of the two sets of right supporting legs. When the existing compact intelligent loading and unloading device of the numerical control turret punch press is used, firstly, a working program is set through the central control module, and then intelligent reclaiming modules such as a plate thickness layering module, a magnetic layering module, a double material detection module and a vacuum suction module are provided on the lifting and reclaiming device. A single piece of sheet material is taken by layering and double material detection processing. Each reclaiming is made for a single piece of sheet material. Then, the lifting and reclaiming device takes the sheet material in a predetermined position. The mobile station moves to the lower part of the taken sheet material. Then, the lifting and reclaiming device automatically places the sheet material on the mobile station and moves to the initial position. The lifting and reclaiming device takes next sheet material after the mobile station moves forwards and resets. Then, the mobile station horizontally moves forwards to the lower part of the feeding device. After the clamp on the feeding device clamps the sheet material and the lifting and reclaiming device takes the next sheet material, the mobile station moves to the lower part of the sheet material taken by the lifting and reclaiming device. Then, after the clamp on the feeding device clamps the sheet material and transmits the sheet material to the original point position of the numerical control turret punch press, the feeding device completes the positioning and clamping work of the sheet material and the punch press. Then, the feeding device moves back to a waiting region. After the numerical control turret punch press completes the processing of the sheet material, the feeding device moves forwards again to clamp the sheet material, and then moves back to the table above a palletizing device. At this moment, the mobile station already moves to the lower part of the lifting and reclaiming device, and avoids the position of the upper side of the palletizing device. At this moment, the feeding device is lowered by the lifter and releases the clamp, so that the blanking and palletizing of the finished material at the palletizing platform are completed. Then, the above process is repeated to realize the loading and unloading automation. It is found from the use of the existing compact intelligent loading and unloading device of the numerical control turret punch press that, firstly, when the feeding device clamps the sheet material through the clamp, because the sheet material is attached to a mobile table, it is very difficult for the feeding device to clamp the sheet material through the clamp, thereby causing poor practicability. Secondly, when the feeding device places the processed sheet material on the palletizing platform, because the feeding device has no limiting device, and the sheet material is easy to skew on the palletizing platform, it is easy to cause the sheet material to slip and bring inconvenience to the transportation of the sheet material, thereby resulting in high use limitations.

### SUMMARY

To solve the above technical problems, the present invention provides a compact intelligent loading and unloading device of a numerical control turret punch press, which can reduce the difficulty of a feeding device for clamping sheet material through a clamp by lifting the sheet material with a certain angle at the front end of the mobile station so as to enhance the practicability and which can enhance the uniformity of the sheet material on the palletizing platform by arranging a limiting device on the palletizing platform to reduce the probability of slippage of the sheet material on the palletizing platform and simultaneously reduce the influence on the transportation of the sheet material on the palletizing platform so as to reduce the use limitations.

A compact intelligent loading and unloading device of a numerical control turret punch press of the present invention comprises mounting frames, a palletizing platform, a mobile station, a feeding device, a lifting and reclaiming device and a central control module, wherein the front side and the rear side of the top end of the mounting frames are respectively provided with two sets of upper fixing frames; the left side and the right side of the lower ends of the two sets of upper fixing frames are respectively provided with four sets of supporting legs; the front side and the rear side of the bottom ends of the two sets of mounting frames are provided with two sets of lower fixing frames respectively; the front side and the rear side of the bottom end of the palletizing platform are respectively connected to the top left side of the two sets of lower fixing frames; the top ends of the two sets of upper fixing frames are respectively provided with two sets of sliding rails; the front side and the rear side of the lower end of the mobile station are respectively slidably clamped with the two sets of sliding rails; a power device is disposed in a central portion of the bottom end of the mobile station; the power device is electrically connected to the central control module; the front end and the rear end of the feeding device are respectively provided with two sets of supporting frames; the bottom region of the feeding device is provided with a clamp; the bottom end of the feeding device is provided with a lifter; the bottom ends of the two sets of supporting frames are respectively connected to the central regions of the top front side and the top rear side of the two sets of upper fixing frames; the feeding device is internally provided with a drive module; the drive module is electrically connected to the central control module; the front end and the rear end of the lifting and reclaiming device are respectively provided with two sets of lifting devices; the bottom end of the lifting and reclaiming device is provided with an intelligent reclaiming module; a lifting device of the lifting and reclaiming device is provided with a driver; the driver and the intelligent reclaiming module are electrically connected to the central control module; and the front side and the rear side of the left end of the central control module are respectively connected to the right ends of the two sets of right supporting legs; the device further comprises two sets of hanging rods, a connecting plate, a lifting plate and a counterweight plate; a working chamber is arranged in the front region of the mobile station; the top ends of the two sets of hanging rods are respectively connected to the left and right regions of the top front side of the working chamber of the mobile station; the front regions of the left end and the right end of the connecting plate are respectively hinged to the bottom regions of the inner ends of the two sets of hanging rods; the top front side and the top rear side of the working chamber are respectively provided with a front extending hole and a rear extending hole in a communication mode; the bottom end of the lifting plate penetrates through the front extending hole from the upper side of the mobile station and extends into the working chamber; the bottom end of the lifting plate is connected to the top front side of the connecting plate; the bottom end of the counterweight plate penetrates through the rear extending hole from the upper side of the mobile station and extends into the working chamber; the bottom end of the counterweight plate is connected to the top rear side of the connecting plate; the device further comprises a mounting block, a regulator, two sets of extruding plates, a left driving rod, a right driving rod, an adjusting gear, a pressing threaded rod, a left limiting ring, a right limiting ring, a left return spring, a right return spring, a left baffle and a right baffle; the bottom end of the mounting block is connected to the front side of the top central region of the palletizing platform; the top end of the mounting block is connected to the bottom end of the regulator; a penetrating hole is penetrated on the top end of the mounting block; a threading-out hole is penetrated on the bottom end of the palletizing platform; the top end of the threading-out hole is in communication with the bottom end of the penetrating hole; a control cavity is arranged in the regulator; an inserting opening is arranged in the central region of the bottom end of the control cavity and the top end of the penetrating hole in a communication mode; the rear side of the central region of the left end and the front side of the central region of the right end of the control cavity are respectively provided with two sets of telescopic holes; the left rear end of the left driving rod and the right rear end of the right driving rod are respectively connected to the central region of the front ends of the two sets of extruding plates; the right end of the left driving rod and the left end of the right driving rod respectively penetrate through the two sets of telescopic holes from the left side and the right side of the regulator and extend into the working chamber; the left limiting ring and the right limiting ring are respectively slidably sleeved with the left driving rod and the right driving rod; the bottom ends of the left limiting ring and the right limiting ring are respectively connected to the right region of the front side of the bottom end and the left region of the rear side of the bottom end of the working chamber; the right end of the left driving rod and the left end of the right driving rod are respectively connected to the left central region of the left baffle and the right central region of the right baffle; the left return spring and the right return spring are respectively movably sleeved with the right region of the left driving rod and the left region of the right driving rod; the left end and the right end of the left return spring are respectively attached to the right end of the left limiting ring and the left end of the left baffle; the left end and the right end of the right return spring are respectively attached to the left end of the right limiting ring and the right end of the right baffle; the top end of the working chamber of the regulator is provided with an extending hole in a communication mode; the bottom end of the pressing threaded rod penetrates through the extending hole from the upper side of the regulator and extends into the working chamber; an internal threaded hole is penetrated in the central region of the top end of the adjusting gear; the bottom end of the pressing threaded rod is screwed through the internal threaded hole from the upper side of the adjusting gear and extends to the lower side of the adjusting gear; the bottom end of the pressing threaded rod penetrates through the inserting opening from the inside of the working chamber and extends into the penetrating hole; the right side of the rear end of the left driving rod and the left side of the front end of the right driving rod are respectively provided with two sets of racks; and the front region and the rear region of the circumferential side wall of the adjusting gear are respectively meshed with the two sets of racks.

The compact intelligent loading and unloading device of the numerical control turret punch press of the present invention further comprises a rotating ring and two sets of fixing rods; a rotating cavity is arranged in the bottom region of the adjusting gear; the rotating ring is rotatably clamped with the rotating cavity; the bottom end of the rotating cavity is provided with an annular hole in a communication mode; the top ends of the two sets of fixing rods respectively penetrate through the annular hole from the left side and the rear side of the bottom end of the adjusting gear and extend into the rotating cavity; and the top ends of the two sets of fixing rods are respectively connected to the left side and the right side of the bottom end of the rotating ring.

The compact intelligent loading and unloading device of the numerical control turret punch press of the present invention further comprises two sets of additional plates, two sets of lifting plates and two sets of pulling springs; two sets of displacement cavities are respectively arranged in the central regions of the two sets of extruding plates; two sets of slide rails are respectively arranged on the central regions of the inner ends of the two sets of displacement cavities in a communication mode; the two sets of lifting plates are respectively slidably clamped with the two sets of displacement cavities; the central regions of the inner ends of the two sets of lifting plates are respectively provided with two sets of synchronous rods; the two sets of synchronous rods respectively penetrate through the two sets of sliding rails from the inside of the two sets of displacement cavities and respectively extend to the outside of the two sets of displacement cavities; the inner ends of the two sets of synchronous rods are respectively connected to the bottom ends of the central regions of the outer ends of the two sets of additional plates; the outer ends of the two sets of additional plates are respectively attached to the inner ends of the two sets of extruding plates; the two sets of pulling springs are respectively connected to the top central regions of the two sets of displacement cavities; and the bottom ends of the two sets of pulling springs are respectively connected to the top central regions of the two sets of lifting rods.

The compact intelligent loading and unloading device of the numerical control turret punch press of the present invention further comprises an extruding block; and the central region of the bottom end of the extruding block is concentrically connected to the top end of the pressing threaded rod.

The compact intelligent loading and unloading device of the numerical control turret punch press of the present invention further comprises a non-slip mat; and the bottom end of the non-slip mat is connected to the top end of the extruding block.

The compact intelligent loading and unloading device of the numerical control turret punch press of the present invention further comprises a reinforcing ring and two sets of reinforcing rods; the reinforcing ring is slidably sleeved with the pressing threaded rod; and the top regions of the inner ends of the two sets of reinforcing rods are respectively connected to the left end and the right end of the outer circumferential side wall of the reinforcing ring.

The compact intelligent loading and unloading device of the numerical control turret punch press of the present invention further comprises a sliding rod and two sets of supporting frames; the front ends of the two sets of supporting frames are respectively connected to the rear central regions of the two sets of extruding plates; the bottom end of the sliding rod is connected to the top rear side of the palletizing platform; the top end of the sliding rod is provided with a limiting rail; and the bottom ends of the rear sides of the two sets of supporting frames are slidably clamped in the limiting rail.

The compact intelligent loading and unloading device of the numerical control turret punch press of the present invention further comprises a grounding plate; the left end of the grounding plate is welded to the bottom region of the right end of the supporting leg on the right front side; and a grounding hole is penetrated in the right region of the front end of the grounding plate.

Compared with the prior art, the present invention has the beneficial effects: firstly, when the lifting and reclaiming device places the sheet material on a mobile station, the front side of the bottom end of the sheet material is lifted by the top end of the lifting plate, and simultaneously the central region of the sheet material extrudes the counterweight plate. According to a lever principle, a counterweight block moves down so that the lifting plate always keeps the front region of the sheet material in a lifted state. In this way, when the mobile station moves to the position of the feeding device, the feeding device can easily extend to the bottom end of the sheet material through the clamp to clamp the sheet material, thereby reducing the difficulty of the feeding device for clamping the sheet material through the clamp by lifting the sheet material with a certain angle at the front end of the mobile station, thereby enhancing practicality. Moreover, after the sheet material is processed, in the process that the feeding device clamps the sheet material through the clamp and places the sheet material on the palletizing platform, the feeding device firstly drives the sheet material to decline. At this moment, the feeding device firstly comes into contact with the pressing threaded rod and extrudes down the pressing threaded rod. Then, the pressing threaded rod moves down. At the same time, the pressing threaded rod rotates through the engagement between an external thread of the pressing threaded rod and an internal thread of the adjusting gear to rotate the adjusting gear in the regulator. Then, the adjusting gear respectively drives the two sets of driving rods through the two sets of racks to extend from the regulator. At this time, the two sets of driving rods respectively drive the two sets of extruding plates to move away. At the same time, the two sets of extruding plates respectively extrude the two sets of return springs through the two sets of baffles and the two sets of limiting rings. As the feeding device pushes the pressing threaded rod to continuously move down, the adjusting gear continuously pushes the two sets of extruding plates through the two sets of driving rods to move away. When the feeding device places the sheet material on the palletizing platform, the feeding device starts to move up to reset at this time, and simultaneously, the two sets of return springs push the two sets of driving rods through the two sets of baffles to retract into the regulator. At this time, the two sets of driving rods respectively drive the two sets of extruding plates to move close to each other until the inner ends of the two sets of extruding plates come into contact with the sheet material and the sheet material is clamped under the power of the two sets of return springs. In this way, all the sheet material can be aligned on both sides. When the two sets of driving rods continuously retract into the regulator, the two sets of driving rods respectively drive the adjusting gear to rotate reversely. Then, the adjusting gear rotates on the pressing threaded rod to move the pressing threaded rod up to prepare for the next unloading of the feeding device, thereby enhancing the uniformity of the sheet material on the palletizing platform by arranging a limiting device on the palletizing platform, simultaneously reducing the probability of slippage of the sheet material on the palletizing platform and reducing the influence on the transportation of the sheet material on the palletizing platform so as to reduce the use limitations.

### BRIEF DESCRIPTION OF DRAWINGS

FIG. 1 is a structural schematic diagram of the present invention;

FIG. 2 is a structural schematic diagram of connection of two sets of extruding plates and two sets of driving rods of the present invention;

FIG. 3 is a structural schematic diagram of connection of a lifting plate and a connecting plate of the present invention;

FIG. 4 is a structural schematic diagram of connection of an adjusting gear and a rotating ring of the present invention;

FIG. 5 is a local amplified structural schematic diagram of A of the present invention; and

FIG. 6 is a local amplified structural schematic diagram of B of the present invention.

Reference Signs: 1 mounting frame; 2 palletizing platform; 3 mobile station; 4 feeding device; 5 lifting and reclaiming device; 6 central control module; 7 two sets of hanging rods; 8 connecting plate; 9 lifting plate; 10 counterweight plate; 11 mounting block; 12 regulator; 13 two sets of extruding plates; 14 left driving rod; 15 right driving rod; 16 adjusting gear; 17 pressing threaded rod; 18 left limiting ring; 19 right limiting ring; 20 left return spring; 21 right return spring; 22 left baffle; 23 right baffle; 24 rotating ring; 25 two sets of fixing rods; 26 two sets of additional plates; 27 two sets of lifting plates; 28 two sets of pulling springs; 29 extruding block; 30 non-slip mat; 31 reinforcing ring; 32 two sets of reinforcing rods; 33 sliding rod; 34 two sets of supporting frames; and 35 grounding plate.

### DETAILED DESCRIPTION OF THE EMBODIMENTS

Specific embodiments of the present invention are further described below in detail in combination with drawings and the embodiments. The following embodiments are only used for illustrating the present invention, not used for limiting the scope of the present invention.

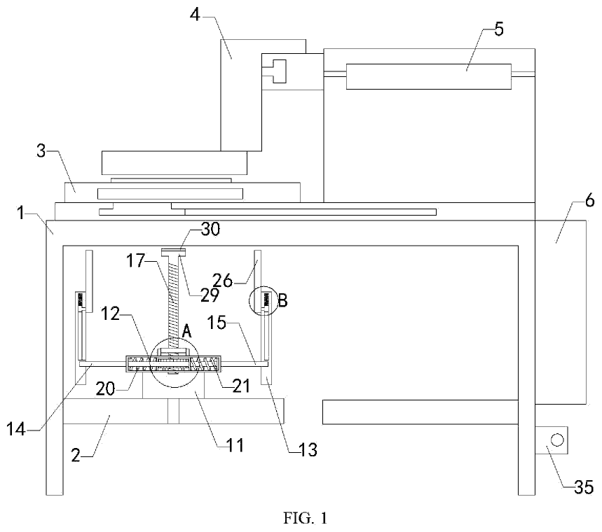

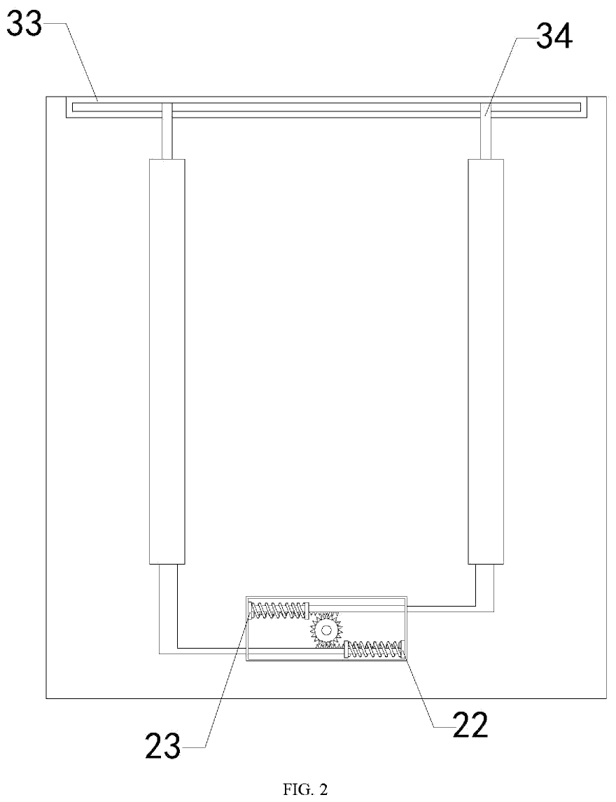

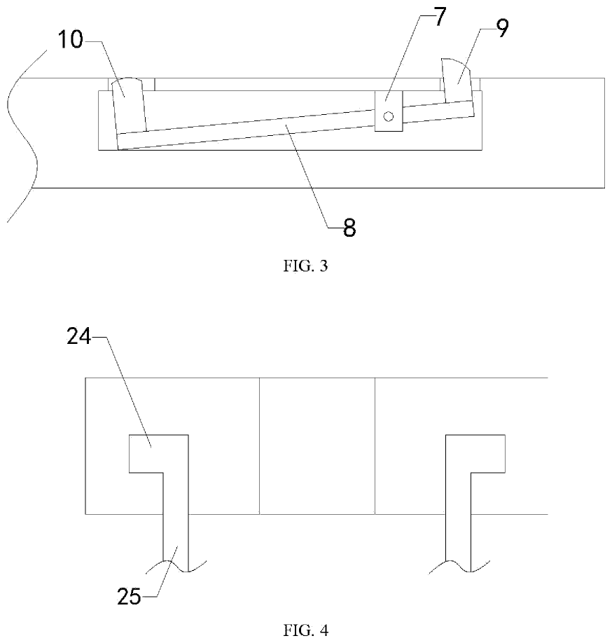

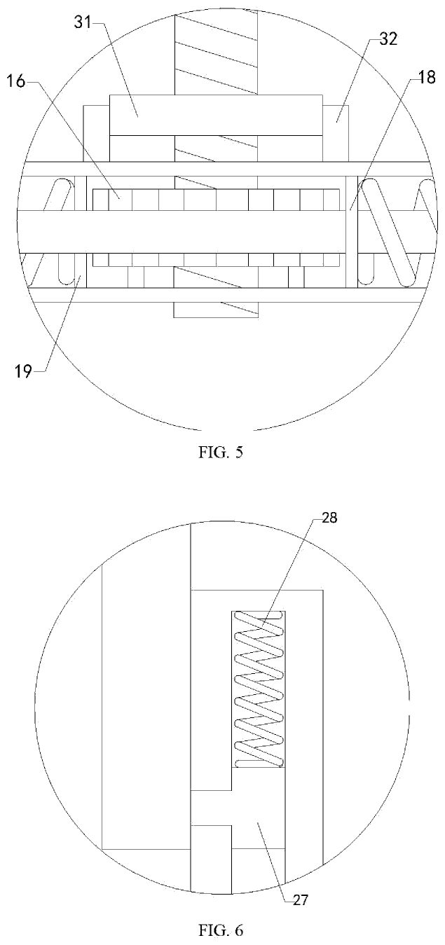

As shown in FIG. 1 to FIG. 6, a compact intelligent loading and unloading device of a numerical control turret punch press of the present invention comprises mounting frames 1, a palletizing platform 2, a mobile station 3, a feeding device 4, a lifting and reclaiming device 5 and a central control module 6, wherein the front side and the rear side of the top end of the mounting frames 1 are respectively provided with two sets of upper fixing frames; the left side and the right side of the lower ends of the two sets of upper fixing frames are respectively provided with four sets of supporting legs; the front side and the rear side of the bottom ends of the two sets of mounting frames 1 are provided with two sets of lower fixing frames respectively; the front side and the rear side of the bottom end of the palletizing platform 2 are respectively connected to the top left side of the two sets of lower fixing frames; the top ends of the two sets of upper fixing frames are respectively provided with two sets of sliding rails; the front side and the rear side of the lower end of the mobile station 3 are respectively slidably clamped with the two sets of sliding rails; a power device is disposed in a central portion of the bottom end of the mobile station 3; the power device is electrically connected to the central control module 6; the front end and the rear end of the feeding device 4 are respectively provided with two sets of supporting frames; the bottom region of the feeding device 4 is provided with a clamp; the bottom end of the feeding device 4 is provided with a lifter; the bottom ends of the two sets of supporting frames are respectively connected to the central regions of the top front side and the top rear side of the two sets of upper fixing frames; the feeding device 4 is internally provided with a drive module; the drive module is electrically connected to the central control module 6; the front end and the rear end of the lifting and reclaiming device 5 are respectively provided with two sets, of lifting devices; the bottom end of the lifting and reclaiming device 5 is provided with an intelligent reclaiming module; a lifting device of the lifting and reclaiming device 5 is provided with a driver; the driver and the intelligent reclaiming module are electrically connected to the central control module 6; and the front side and the rear side of the left end of the central control module 6 are respectively connected to the right ends of the two sets of right supporting legs; the device further comprises two sets of hanging rods 7, a connecting plate 8, a lifting plate 9 and a counterweight plate 10; a working chamber is arranged in the front region of the mobile station 3; the top ends of the two sets of hanging rods 7 are respectively connected to the left and right regions of the top front side of the working chamber of the mobile station 3; the front regions of the left end and the right end of the connecting plate 8 are respectively hinged to the bottom regions of the inner ends of the two sets of hanging rods 7; the top front side and the top rear side of the working chamber are respectively provided with a front extending hole and a rear extending hole in a communication mode; the bottom end of the lifting plate 9 penetrates through the front extending hole from the upper side of the mobile station 3 and extends into the working chamber; the bottom end of the lifting plate 9 is connected to the top front side of the connecting plate 8; the bottom end of the counterweight plate 10 penetrates through the rear extending hole from the upper side of the mobile station 3 and extends into the working chamber; the bottom end of the counterweight plate 10 is connected to the top rear side of the connecting plate 8; the device further comprises a mounting block 11, a regulator 12, two sets of extruding plates 13, a left driving rod 14, a right driving rod 15, an adjusting gear 16, a pressing threaded rod 17, a left limiting ring 18, a right limiting ring 19, a left return spring 20, a right return spring 21, a left baffle 22 and a right baffle 23; the bottom end of the mounting block 11 is connected to the front side of the top central region of the palletizing platform 2; the top end of the mounting block 11 is connected to the bottom end of the regulator 12; a penetrating hole is penetrated on the top end of the mounting block 11; a threading-out hole is penetrated on the bottom end of the palletizing platform 2; the top end of the threading-out hole is in communication with the bottom end of the penetrating hole; a control cavity is arranged in the regulator 12; an inserting opening is arranged in the central region of the bottom end of the control cavity and the top end of the penetrating hole in a communication mode; the rear side of the central region of the left end and the front side of the central region of the right end of the control cavity are respectively provided with two sets of telescopic holes; the left rear end of the left driving rod 14 and the right rear end of the right driving rod are respectively connected to the central region of the front ends of the two sets of extruding plates 13; the right end of the left driving rod 14 and the left end of the right driving rod 15 respectively penetrate through the two sets of telescopic holes from the left side and the right side of the regulator 12 and extend into the working chamber; the left limiting ring 18 and the right limiting ring 19 are respectively slidably sleeved with the left driving rod 14 and the right driving rod; the bottom ends of the left limiting ring 18 and the right limiting ring 19 are respectively connected to the right region of the front side of the bottom end and the left region of the rear side of the bottom end of the working chamber; the right end of the left driving rod 14 and the left end of the right driving rod 15 are respectively connected to the left central region of the left baffle 22 and the right central region of the right baffle 23; the left return spring 20 and the right return spring 21 are respectively movably sleeved with the right region of the left driving rod 14 and the left region of the right driving rod 15; the left end and the right end of the left return spring 20 are respectively attached to the right end of the left limiting ring 18 and the left end of the left baffle 22; the left end and the right end of the right return spring 21 are respectively attached to the left end of the right limiting ring 19 and the right end of the right baffle 23; the top end of the working chamber of the regulator 12 is provided with an extending hole in a communication mode; the bottom end of the pressing threaded rod 17 penetrates through the extending hole from the upper side of the regulator 12 and extends into the working chamber; an internal threaded hole is penetrated in the central region of the top end of the adjusting gear 16; the bottom end of the pressing threaded rod 17 is screwed through the internal threaded hole from the upper side of the adjusting gear 16 and extends to the lower side of the adjusting gear 16; the bottom end of the pressing threaded rod 17 penetrates through the inserting opening from the inside of the working chamber and extends into the penetrating hole; the right side of the rear end of the left driving rod 14 and the left side of the front end of the right driving rod 15 are respectively provided with two sets of racks; and the front region and the rear region of the circumferential side wall of the adjusting gear 16 are respectively meshed with the two sets of racks. Firstly, when the lifting and reclaiming device places the sheet material on a mobile station, the front side of the bottom end of the sheet material is lifted by the top end of the lifting plate, and simultaneously the central region of the sheet material extrudes the counterweight plate. According to a lever principle, a counterweight block moves down so that the lifting plate always keeps the front region of the sheet material in a lifted state. In this way, when the mobile station moves to the position of the feeding device, the feeding device can easily extend to the bottom end of the sheet material through the clamp to clamp the sheet material, thereby reducing the difficulty of the feeding device for clamping the sheet material through the clamp by lifting the sheet material with a certain angle at the front end of the mobile station, thereby enhancing practicality. Moreover, after the sheet material is processed, in the process that the feeding device clamps the sheet material through the clamp and places the sheet material on the palletizing platform, the feeding device firstly drives the sheet material to decline. At this moment, the feeding device firstly comes into contact with the pressing threaded rod and extrudes down the pressing threaded rod. Then, the pressing threaded rod moves down. At the same time, the pressing threaded rod rotates through the engagement between an external thread of the pressing threaded rod and an internal thread of the adjusting gear to rotate the adjusting gear in the regulator. Then, the adjusting gear respectively drives the two sets of driving rods through the two sets of racks to extend from the regulator. At this time, the two sets of driving rods respectively drive the two sets of extruding plates to move away. At the same time, the two sets of extruding plates respectively extrude the two sets of return springs through the two sets of baffles and the two sets of limiting rings. As the feeding device pushes the pressing threaded rod to continuously move down, the adjusting gear continuously pushes the two sets of extruding plates through the two sets of driving rods to move away. When the feeding device places the sheet material on the palletizing platform, the feeding device starts to move up to reset at this time, and simultaneously, the two sets of return springs push the two sets of driving rods through the two sets of baffles to retract into the regulator. At this time, the two sets of driving rods respectively drive the two sets of extruding plates to move close to each other until the inner ends of the two sets of extruding plates come into contact with the sheet material and the sheet material is clamped under the power of the two sets of return springs. In this way, all the sheet material can be aligned on both sides. When the two sets of driving rods continuously retract into the regulator, the two sets of driving rods respectively drive the adjusting gear to rotate reversely. Then, the adjusting gear rotates on the pressing threaded rod to move the pressing threaded rod up to prepare for the next unloading of the feeding device, thereby enhancing the uniformity of the sheet material on the palletizing platform by arranging a limiting device on the palletizing platform, simultaneously reducing the probability of slippage of the sheet material on the palletizing platform and reducing the influence on the transportation of the sheet material on the palletizing platform so as to reduce the use limitations.

The compact intelligent loading and unloading device of the numerical control turret punch press of the present invention further comprises a rotating ring 24 and two sets of fixing rods 25; a rotating cavity is arranged in the bottom region of the adjusting gear 16; the rotating ring 24 is rotatably clamped with the rotating cavity; the bottom end of the rotating cavity is provided with an annular hole in a communication mode; the top ends of the two sets of fixing rods 25 respectively penetrate through the annular hole from the left side and the rear side of the bottom end of the adjusting gear 16 and extend into the rotating cavity; and the top ends of the two sets of fixing rods 25 are respectively connected to the left side and the right side of the bottom end of the rotating ring 24. The adjusting gear is connected to the bottom end of the rotating cavity of the regulator through the rotating ring and the two sets of fixing rods, so as to enhance the rotation stability of the adjusting gear.

The compact intelligent loading and unloading device of the numerical control turret punch press of the present invention further comprises two sets of additional plates 26, two sets of lifting plates 27 and two sets of pulling springs 28; two sets of displacement cavities are respectively arranged in the central regions of the two sets of extruding plates 13; two sets of slide rails are respectively arranged on the central regions of the inner ends of the two sets of displacement cavities in a communication mode; the two sets of lifting plates 27 are respectively slidably clamped with the two sets of displacement cavities; the central regions of the inner ends of the two sets of lifting plates 27 are respectively provided with two sets of synchronous rods; the two sets of synchronous rods respectively penetrate through the two sets of sliding rails from the inside of the two sets of displacement cavities and respectively extend to the outside of the two sets of displacement cavities; the inner ends of the two sets of synchronous rods are respectively connected to the bottom ends of the central regions of the outer ends of the two sets of additional plates 26; the outer ends of the two sets of additional plates 26 are respectively attached to the inner ends of the two sets of extruding plates 13; the two sets of pulling springs 28 are respectively connected to the top central regions of the two sets of displacement cavities; and the bottom ends of the two sets of pulling springs 28 are respectively connected to the top central regions of the two sets of lifting rods. In the process that the sheet material is driven by the feeding device to move down, the sheet material extrudes the two sets of additional plates, and then the two sets of additional plates slide down on the two sets of extruding plates through the two sets of lifting plates respectively. At the same time, the two sets of lifting plates respectively pull the two sets of pulling springs, and then the two sets of additional plates move to the outside along with the two sets of extruding plates. When the two sets of additional plates move out of the bottom end of the sheet material, the two sets of additional plates are respectively reset by the two sets of lifting plates under the pulling of the two sets of pulling springs, which can enhance the adjusting height of the two sets of extruding plates, thereby reducing the use limitations.

The compact intelligent loading and unloading device of the numerical control turret punch press of the present invention further comprises an extruding block 29; and the central region of the bottom end of the extruding block 29 is concentrically connected to the top end of the pressing threaded rod 17. The contact area between the top end of the pressing threaded rod and the feeding device can be increased through the extruding block, and the probability that the feeding device is extruded and damaged can be reduced, thereby enhancing the safety.

The compact intelligent loading and unloading device of the numerical control turret punch press of the present invention further comprises a non-slip mat 30; and the bottom end of the non-slip mat 30 is connected to the top end of the extruding block 29. The non-slip mat can effectively increase the friction between the extruding block and the feeding device, so as to prevent the pressing threaded rod from rotating on the regulator, thereby enhancing the practicality.

The compact intelligent loading and unloading device of the numerical control turret punch press of the present invention further comprises a reinforcing ring 31 and two sets of reinforcing rods 32; the reinforcing ring 31 is slidably sleeved with the pressing threaded rod 17; and the top regions of the inner ends of the two sets of reinforcing rods 32 are respectively connected to the left end and the right end of the outer circumferential side wall of the reinforcing ring 31. The reinforcing ring enables the pressing threaded rod to move longitudinally more stably, thereby enhancing the stability.

The compact intelligent loading and unloading device of the numerical control turret punch press of the present invention further comprises a sliding rod 33 and two sets of supporting frames 34; the front ends of the two sets of supporting frames 34 are respectively connected to the rear central regions of the two sets of extruding plates 13; the bottom end of the sliding rod 33 is connected to the top rear side of the palletizing platform 2; the top end of the sliding rod 33 is provided with a limiting rail; and the bottom ends of the rear sides of the two sets of supporting frames 34 are slidably clamped in the limiting rail. When the two sets of extruding plates move, the two sets of extruding plates slide on the sliding rod through the two sets of supporting frames, thereby making the two sets of extruding plates stabler and enhancing the practicability.

The compact intelligent loading and unloading device of the numerical control turret punch press of the present invention further comprises a grounding plate 35; the left end of the grounding plate 35 is welded to the bottom region of the right end of the supporting leg on the right front side; and a grounding hole is penetrated in the right region of the front end of the grounding plate 35. The device is grounded through the grounding plate, so as to effectively reduce the harm brought by electricity leakage of the device, thereby enhancing the safety.

When the compact intelligent loading and unloading device of the numerical control turret punch press of the present invention works, firstly, a working program is set through the central control module, and then intelligent reclaiming modules such as a plate thickness layering module, a magnetic layering module, a double material detection module and a vacuum suction module are provided on the lifting and reclaiming device. A single piece of sheet material is taken by layering and double material detection processing, and each reclaiming is made for a single piece of sheet material. Then, the lifting and reclaiming device takes the sheet material in a predetermined position. The mobile station moves to the lower part of the taken sheet material. Then, the lifting and reclaiming device automatically places the sheet material on the mobile station and moves to the initial position. When the sheet material is placed on the mobile station, the front side of the bottom end of the sheet material is lifted by the top end of the lifting plate, and simultaneously the central region of the sheet material extrudes the counterweight plate. According to a lever principle, a counterweight block moves down so that the lifting plate always keeps the front region of the sheet material in a lifted state. In this way, when the mobile station moves to the position of the feeding device, the feeding device can easily extend to the bottom end of the sheet material through the clamp to clamp the sheet material. The lifting and reclaiming device takes next sheet material after the mobile station moves forwards and resets. Then, the mobile station horizontally moves forwards to the lower part of the feeding device. After the clamp on the feeding device clamps the sheet material and the lifting and reclaiming device takes the next sheet material, the mobile station moves to the lower part of the sheet material taken by the lifting and reclaiming device. Then, after the clamp on the feeding device clamps the sheet material and transmits the sheet material to the original point position of the numerical control turret punch press, the feeding device completes the positioning and clamping work of the sheet material and the punch press. Then, the feeding device moves back to a waiting region. After the numerical control turret punch press completes the processing of the sheet material, the feeding device moves forwards again to clamp the sheet material, and then moves back to the table above a palletizing device. In the process that the feeding device clamps the sheet material through the clamp and places the sheet material on the palletizing platform, the feeding device firstly drives the sheet material to decline. At this moment, the feeding device firstly comes into contact with the pressing threaded rod and extrudes down the pressing threaded rod. Then, the pressing threaded rod moves down. At the same time, the pressing threaded rod rotates through the engagement between an external thread of the pressing threaded rod and an internal thread of the adjusting gear to rotate the adjusting gear in the regulator. Then, the adjusting gear respectively drives the two sets of driving rods through the two sets of racks to extend from the regulator. At this time, the two sets of driving rods respectively drive the two sets of extruding plates to move away. At the same time, the two sets of extruding plates respectively extrude the two sets of return springs through the two sets of baffles and the two sets of limiting rings. As the feeding device pushes the pressing threaded rod to continuously move down, the adjusting gear continuously pushes the two sets of extruding plates through the two sets of driving rods to move away. When the feeding device places the sheet material on the palletizing platform, the feeding device starts to move up to reset at this time, and simultaneously, the two sets of return springs push the two sets of driving rods through the two sets of baffles to retract into the regulator. At this time, the two sets of driving rods respectively drive the two sets of extruding plates to move close to each other until the inner ends of the two sets of extruding plates come into contact with the sheet material and the sheet material is clamped under the power of the two sets of return springs. In this way, all the sheet material can be aligned on both sides. When the two sets of driving rods continuously retract into the regulator, the two sets of driving rods respectively drive the adjusting gear to rotate reversely. Then, the adjusting gear rotates on the pressing threaded rod to move the pressing threaded rod up to prepare for the next unloading of the feeding device. At this moment, the mobile station already moves to the lower part of the lifting and reclaiming device, and avoids the position of the upper side of the palletizing device. At this moment, the feeding device is lowered by the lifter and releases the clamp, so that the blanking and palletizing of the finished material at the palletizing platform are completed. Then, the above process is repeated to realize the loading and unloading automation.

The terms “front”, “rear”, “left”, “right” and the like used herein are just for the purpose of illustration.

The above descriptions are only preferred embodiments of the present invention. It should be noted that, for those ordinary skilled in the art, several improvements and variations may be made without departing from the technical principles of the present invention, and these improvements and variations should also be considered to be within the protection scope of the present invention.

What is claimed is:

1. A compact intelligent loading and unloading device of a numerical control turret punch press, comprising mounting frames (1), a palletizing platform (2), a mobile station (3), a feeding device (4), a lifting and reclaiming device (5) and a central control module (6), wherein the front side and the rear side of the top end of the mounting frames (1) are respectively provided with two sets of upper fixing frames; the left side and the right side of the lower ends of the two sets of upper fixing frames are respectively provided with four sets of supporting legs; the front side and the rear side of the bottom ends of the two sets of mounting frames (1) are provided with two sets of lower fixing frames respectively; the front side and the rear side of the bottom end of the palletizing platform (2) are respectively connected to the top left side of the two sets of lower fixing frames; the top ends of the two sets of upper fixing frames are respectively provided with two sets of sliding rails; the front side and the rear side of the lower end of the mobile station (3) are respectively slidably clamped with the two sets of sliding rails; a power device is disposed in a central portion of the bottom end of the mobile station (3); the power device is electrically connected to the central control module (6); the front end and the rear end of the feeding device (4) are respectively provided with two sets of supporting frames; the bottom region of the feeding device (4) is provided with a clamp; the bottom end of the feeding device (4) is provided with a lifter; the bottom ends of the two sets of supporting frames are respectively connected to the central regions of the top front side and the top rear side of the two sets of upper fixing frames; the feeding device (4) is internally provided with a drive module; the drive module is electrically connected to the central control module (6); the front end and the rear end of the lifting and reclaiming device (5) are respectively provided with two sets of lifting devices; the bottom end of the lifting and reclaiming device (5) is provided with an intelligent reclaiming module; a lifting device of the lifting and reclaiming device (5) is provided with a driver; the driver and the intelligent reclaiming module are electrically connected to the central control module (6); and the front side and the rear side of the left end of the central control module (6) are respectively connected to the right ends of the two sets of right supporting legs; characterized in that the device further comprises two sets of hanging rods (7), a connecting plate (8), a lifting plate (9) and a counterweight plate (10); a working chamber is arranged in the front region of the mobile station (3); the top ends of the two sets of hanging rods (7) are respectively connected to the left and right regions of the top front side of the working chamber of the mobile station (3); the front regions of the left end and the right end of the connecting plate (8) are respectively hinged to the bottom regions of the inner ends of the two sets of hanging rods (7); the top front side and the top rear side of the working chamber are respectively provided with a front extending hole and a rear extending hole in a communication mode; the bottom end of the lifting plate (9) penetrates through the front extending hole from the upper side of the mobile station (3) and extends into the working chamber; the bottom end of the lifting plate (9) is connected to the top front side of the connecting plate (8); the bottom end of the counterweight plate (10) penetrates through the rear extending hole from the upper side of the mobile station (3) and extends into the working chamber; the bottom end of the counterweight plate (10) is connected to the top rear side of the connecting plate (8); the device further comprises a mounting block (11), a regulator (12), two sets of extruding plates (13), a left driving rod (14), a right driving rod (15), an adjusting gear (16), a pressing threaded rod (17), a left limiting ring (18), a right limiting ring (19), a left return spring (20), a right return spring (21), a left baffle (22) and a right baffle (23); the bottom end of the mounting block (11) is connected to the front side of the top central region of the palletizing platform (2); the top end of the mounting block (11) is connected to the bottom end of the regulator (12); a penetrating hole is penetrated on the top end of the mounting block (11); a threading-out hole is penetrated on the bottom end of the palletizing platform (2); the top end of the threading-out hole is in communication with the bottom end of the penetrating hole; a control cavity is arranged in the regulator (12); an inserting opening is arranged in the central region of the bottom end of the control cavity and the top end of the penetrating hole in a communication mode; the rear side of the central region of the left end and the front side of the central region of the right end of the control cavity are respectively provided with two sets of telescopic holes; the left rear end of the left driving rod (14) and the right rear end of the right driving rod are respectively connected to the central region of the front ends of the two sets of extruding plates (13); the right end of the left driving rod (14) and the left end of the right driving rod (15) respectively penetrate through the two sets of telescopic holes from the left side and the right side of the regulator (12) and extend into the working chamber; the left limiting ring (18) and the right limiting ring (19) are respectively slidably sleeved with the left driving rod (14) and the right driving rod; the bottom ends of the left limiting ring (18) and the right limiting ring (19) are respectively connected to the right region of the front side of the bottom end and the left region of the rear side of the bottom end of the working chamber; the right end of the left driving rod (14) and the left end of the right driving rod (15) are respectively connected to the left central region of the left baffle (22) and the right central region of the right baffle (23); the left return spring (20) and the right return spring (21) are respectively movably sleeved with the right region of the left driving rod (14) and the left region of the right driving rod (15); the left end and the right end of the left return spring (20) are respectively attached to the right end of the left limiting ring (18) and the left end of the left baffle (22); the left end and the right end of the right return spring (21) are respectively attached to the left end of the right limiting ring (19) and the right end of the right baffle (23); the top end of the working chamber of the regulator (12) is provided with an extending hole in a communication mode; the bottom end of the pressing threaded rod (17) penetrates through the extending hole from the upper side of the regulator (12) and extends into the working chamber; an internal threaded hole is penetrated in the central region of the top end of the adjusting gear (16); the bottom end of the pressing threaded rod (17) is screwed through the internal threaded hole from the upper side of the adjusting gear (16) and extends to the lower side of the adjusting gear (16); the bottom end of the pressing threaded rod (17) penetrates through the inserting opening from the inside of the working chamber and extends into the penetrating hole; the right side of the rear end of the left driving rod (14) and the left side of the front end of the right driving rod (15) are respectively provided with two sets of racks; and the front region and the rear region of the circumferential side wall of the adjusting gear (16) are respectively meshed with the two sets of racks.

2. The compact intelligent loading and unloading device of the numerical control turret punch press according to claim 1, characterized in that the device further comprises a rotating ring (24) and two sets of fixing rods (25); a rotating cavity is arranged in the bottom region of the adjusting gear (16); the rotating ring (24) is rotatably clamped with the rotating cavity; the bottom end of the rotating cavity is provided with an annular hole in a communication mode; the top ends of the two sets of fixing rods (25) respectively penetrate through the annular hole from the left side and the rear side of the bottom end of the adjusting gear (16) and extend into the rotating cavity; and the top ends of the two sets of fixing rods (25) are respectively connected to the left side and the right side of the bottom end of the rotating ring (24).

3. The compact intelligent loading and unloading device of the numerical control turret punch press according to claim 2, characterized in that the device further comprises two sets of additional plates (26), two sets of lifting plates (27) and two sets of pulling springs (28); two sets of displacement cavities are respectively arranged in the central regions of the two sets of extruding plates (13); two sets of slide rails are respectively arranged on the central regions of the inner ends of the two sets of displacement cavities in a communication mode; the two sets of lifting plates (27) are respectively slidably clamped with the two sets of displacement cavities; the central regions of the inner ends of the two sets of lifting plates (27) are respectively provided with two sets of synchronous rods; the two sets of synchronous rods respectively penetrate through the two sets of sliding rails from the inside of the two sets of displacement cavities and respectively extend to the outside of the two sets of displacement cavities; the inner ends of the two sets of synchronous rods are respectively connected to the bottom ends of the central regions of the outer ends of the two sets of additional plates (26); the outer ends of the two sets of additional plates (26) are respectively attached to the inner ends of the two sets of extruding plates (13); the two sets of pulling springs (28) are respectively connected to the top central regions of the two sets of displacement cavities; and the bottom ends of the two sets of pulling springs (28) are respectively connected to the top central regions of the two sets of lifting rods.

4. The compact intelligent loading and unloading device of the numerical control turret punch press according to claim 3, characterized in that the device further comprises an extruding block (29); and the central region of the bottom end of the extruding block (29) is concentrically connected to the top end of the pressing threaded rod (17).

5. The compact intelligent loading and unloading device of the numerical control turret punch press according to claim 4, characterized in that the device further comprises a non-slip mat (30); and the bottom end of the non-slip mat (30) is connected to the top end of the extruding block (29).

6. The compact intelligent loading and unloading device of the numerical control turret punch press according to claim 5, characterized in that the device further comprises a reinforcing ring (31) and two sets of reinforcing rods (32); the reinforcing ring (31) is slidably sleeved with the pressing threaded rod (17); and the top regions of the inner ends of the two sets of reinforcing rods (32) are respectively connected to the left end and the right end of the outer circumferential side wall of the reinforcing ring (31).

7. The compact intelligent loading and unloading device of the numerical control turret punch press according to claim 6, characterized in that the device further comprises a sliding rod (33) and two sets of supporting frames (34); the front ends of the two sets of supporting frames (34) are respectively connected to the rear central regions of the two sets of extruding plates (13); the bottom end of the sliding rod (33) is connected to the top rear side of the palletizing platform (2); the top end of the sliding rod (33) is provided with a limiting rail; and the bottom ends of the rear sides of the two sets of supporting frames (34) are slidably clamped in the limiting rail.

8. The compact intelligent loading and unloading device of the numerical control turret punch press according to claim 7, characterized in that the device further comprises a grounding plate (35); the left end of the grounding plate (35) is welded to the bottom region of the right end of the supporting leg on the right front side; and a grounding hole is penetrated in the right region of the front end of the grounding plate (35)
